(19) United States
(12) Patent Application Publication
(10) Pub. No.: US 2015/0300326 A1
(43) Pub. Date: Oct. 22, 2015

(54) A CONCENTRATED SOLAR THERMAL POWER PLANT AND METHOD

(71) Applicant: NUOVO PIGNONE SRL, Florence (IT)

(72) Inventors: Adi Narayana NAMBURI, Bangalore (IN); Bhaskara KOSAMANA, Bangalore (IN); Rakesh GOVINDASAMY, Bangalore (IN)

(21) Appl. No.: 14/650,295

(22) PCT Filed: Dec. 5, 2013
(86) PCT No.: PCT/EP2013/075719

§ 371 Date: Jun. 5, 2015

(30) Foreign Application Priority Data
Dec. 7, 2012 (IT) FI 2012 A 000273

(51) Int. Cl. F03G 6/06; F24J 2/30

(52) U.S. Cl. CPC F03G 6/065; F24J 2/30

(57) ABSTRACT

The concentrated solar power (CSP) plant comprises a solar field and a vapor turbine system. The vapor turbine system includes a vapor turbine arrangement. The vapor turbine arrangement receives super-heated vapor generated by heating a working fluid circulating in the vapor turbine system. The plant further comprises a thermal transfer system configured for transferring solar thermal energy from the solar field to the vapor turbine system. Moreover, a supplemental-energy delivery device is provided, which is configured for superheating the vapor, when the solar thermal energy from the solar field is insufficient to generate superheated vapor.

### BACKGROUND

The described subject matter relates to systems, methods and plants, which use solar thermal energy to produce useful mechanical energy, optionally converted in electric energy.

More specifically, the described subject matter relates to concentrated solar thermal power plants, wherein a solar field is provided for collecting solar energy and conveying the heat collected by the solar field to a thermodynamic cycle, wherein thermal energy is converted into mechanical energy for driving a load, such as a turbomachine or an electric generator for converting mechanical power in electric power.

Conventional solar thermal power technologies generally include collectors that focus the energy from the sun so that the high pressure and temperature needed for efficient power generation may be obtained. Different kinds of collectors are known in the art. They usually are combined to form a so-called solar field, wherein a plurality of collectors concentrate the solar energy in a heat collecting circuit, wherein a heat transfer fluid or heat transfer medium circulates, said medium transferring the collected thermal energy into a thermodynamic cycle.

For example, the collected solar thermal energy can be used in a Rankine cycle to generate mechanical power, which can optionally be converted into electrical power by an electric generator.

The efficiency of the thermodynamic cycle depends upon the available solar thermal energy and in particular upon the pressure and temperature conditions, which can be achieved in the thermodynamic cycle.

The power, which can be collected by the solar field, is strongly dependent upon the weather conditions as well as from the position of the sun during the day. In some embodiments of the prior art heat collecting and storing means are used for storing excess thermal energy available during the central part of the day, which can be used to improve the overall efficiency of the thermodynamic cycle during periods where less solar energy is available. This notwithstanding, the solar thermal power plants must be turned off for several hours a day due to insufficient solar power availability or lack of solar power, e.g. at night and during sunrise and sunset.

FIG. 1 illustrates a concentrated solar thermal power plant 1 of the current art. Solar energy is collected by a solar field schematically shown at 3. The solar field 3 can be comprised of a plurality of solar concentrators 5, for example in the form of parabolic troughs, focusing the solar energy on pipes 5A arranged in the focus of the troughs and made of heat conducting material, wherein a heat transfer medium flows. The pipes 5A collecting the thermal energy from individual rows of troughs 5 merge in a duct 7. The heat transfer medium flowing in the duct 7 delivers thermal energy to a system, where thermal power is converted into mechanical power, e.g. via a thermodynamic cycle, such as a Rankine cycle by means of a steam turbine.

A plurality of heat exchangers 9, 11, 13, 15, arranged in sequence are used to transfer thermal energy from the heat transfer medium to a working fluid of a thermodynamic cycle. The heat exchanger 9 is a super-heater, where a working fluid circulating in a closed circuit 17 is superheated. The heat exchanger 11 is a steam generator, where the working fluid is transformed from a liquid state to a saturated vapor state. If the working fluid is water, the vapor is water vapor, i.e. steam. The heat exchanger 13 forms part of a solar pre-heater, wherein the working fluid is pre-heated in the liquid state before being transformed into steam or vapor.

The heat exchanger 15 forms part of a solar re-heater, which is used to re-heat the steam or vapor circulating in the closed circuit 17 between a first expansion step and a second expansion step performed into sequentially arranged high-pressure steam or vapor turbine 19 and low-pressure steam or vapor turbine 21. The heat transfer medium entering the re-heater is at the same temperature as the heat transfer medium entering the super-heater 9 and connection between the duct 7 and the re-heater 13 is through a bypass line 7A.

A return duct 23 returns the heat transfer medium or heat transfer fluid from the heat exchangers towards the solar field. An expansion vessel 24 is provided upstream of the return duct 23.

A bypass line 25 is provided, through which part or the entire heat transfer medium flow can be diverted when the thermal energy collected by the solar field 3 is higher than the thermal energy required by the circuit 17 and/or when the thermodynamic cycle is shut down for whatever reason. Heat contained in the heat transfer medium flowing through the bypass line 25 can be transferred in a heat exchanger 27 to a heat storing medium, e.g. a salt, collected in a hot-salt storage tank 29. When the thermal energy collected by the solar field 3 is insufficient to run the thermodynamic cycle in circuit 17, supplemental heat can be provided by the hot salt stored in storage tank 29, by pumping the hot salt from the storage tank 29 to a cold-salt storage tank 31 via the heat exchanger 27, where thermal energy is transferred by indirect heat exchange from the heat-storage salt to the heat transfer medium circulating in by-pass line 25.

The working fluid circulating in the circuit 17 usually performs a so called Rankine cycle and is usually water. In some embodiments the Rankine cycle can be an Organic Rankine Cycle, using an organic fluid, e.g. cyclopentane.

The working fluid delivered by the super-heater 9 is in a superheated gaseous state and is firstly expanded in the high-pressure turbine 19 and subsequently further expanded in the low-pressure turbine 21. Between the first expansion and the second expansion the working fluid can be re-heated by circulating the working fluid in a circuit 33, including the solar re-heater 15. The two turbines 21 and 19 can be used to drive an electric generator 22, which can in turn deliver electric power to an electric distribution grid schematically shown at G.

Spent and optionally partly condensed steam or vapor from the low-pressure turbine 21 is condensed in a condenser 35 and possibly pre-heated in a low pressure pre-heater 37 by means of heat exchange with a side flow of the partially expanded vapor or steam, which bleeds from an intermediate stage of the low-pressure turbine 21, for example. A circulating pump 39 pumps the working fluid to a de-aerator 41. A feed water pump 40 pumps the working fluid from the de-aerator 41 through the solar pre-heater 13, the steam generator 11 and the super-heater 9.

FIG. 2 shows a typical steam turbine arrangement with a high-pressure steam turbine 19 and a low-pressure steam turbine 21 connected to one another through a gearbox 20. Reference number 15 designates again a re-heater. If the solar field does not provide sufficient energy to run the thermodynamic cycle at the minimum load conditions, the thermodynamic cycle must be shut down.

There is a need for improving the efficiency of the concentrated solar power plant of the prior art, especially when the available solar energy is below a minimum threshold and the available solar energy is insufficient to superheat the steam.

### SUMMARY OF THE INVENTION

According to a first aspect, a concentrated solar power (CSP) plant is provided comprising: a solar field; a vapor turbine system comprising a vapor turbine arrangement, and a thermal transfer system for transferring solar thermal energy from the solar field to the vapor turbine system. The vapor system comprises a vapor generator arrangement and a superheater to convert a liquid working fluid circulating in the turbine system into superheated vapor. The vapor turbine arrangement is configured for receiving the superheated vapor. Expansion of the superheated vapor generates mechanical power, which can be used for electric generator purposes or for mechanical drive applications, or both. The vapor turbine system can include a re-heating arrangement and/or one or more sequentially arranged vapor turbines or turbine sections operating at different vapor pressure. According to some embodiments, the plant further comprises at least one supplemental-energy delivery device configured for superheating the vapor, when the solar thermal energy from said solar field is insufficient to generate superheated vapor.

In some embodiments the vapor system uses water (H2O) as a working fluid. In this case, water vapor, i.e. steam is processed in the thermodynamic cycle.

The supplemental-energy delivery device can comprise a source of thermal energy different from the solar field, e.g. a heat recovery plant, or a system generating heat by burning a fuel, e.g. gas from biomass or the like.

In some embodiments, the supplemental-energy delivery device can comprise a source of mechanical energy, e.g. a vapor compressor. The vapor compressor processes wet vapor, saturated vapor or partly superheated vapor generated exploiting the available solar power, to bring the vapor to a sufficiently superheated condition.

In some embodiments the supplemental-energy delivery device can include more than one energy sources, e.g. a source of mechanical energy and a source of thermal energy in combination.

The vapor, which has been superheated using the supplemental energy can be expanded in the vapor turbine arrangement. In some embodiments expansion is performed only in a section of the vapor turbine arrangement, e.g. in a low-pressure vapor turbine or in the low-pressure stages of a multi-stage vapor turbine. In the present disclosure and enclosed claims the term “low-pressure turbine” and “high-pressure turbine” can refer either to separate machines, or else to sections or stages of a single vapor turbine. In some embodiments, therefore, when the supplemental-energy delivery device is operative, the high-pressure vapor turbine is by-passed.

According to a further aspect, a method for operating a concentrated solar power plant is provided. According to some embodiments the method comprises collecting solar thermal energy with a solar field; generating superheated vapor by heating a working fluid with said solar thermal energy; expanding said superheated vapor in a vapor turbine arrangement and generating mechanical energy therewith. The method further comprises supplementing the solar thermal energy with supplemental energy delivered by a supplemental-energy delivery device for superheating vapor delivered to the vapor turbine arrangement when the solar thermal energy is insufficient to generate sufficient superheated vapor.

The supplemental energy delivered by the supplemental-energy delivery device extends the period of operability of the concentrated solar plant, allowing production of useful mechanical or electrical power even in periods during which the available solar power is insufficient to generate sufficient superheated vapor.

If a vapor compressor is used as a source of supplemental energy for superheating the vapor, the vapor compressor can be driven by electric energy from an electric grid, or using electric energy generated by the vapor turbine of the solar plant, or directly by mechanical energy generated by the vapor turbine. The supplemental power or energy delivered to the vapor is less than the additional power, which can be produced by the extended period of operation of the concentrated solar power plant, which can be obtained by supplementing the solar thermal energy with the supplemental-energy source. The energetic balance is thus positive, in the sense that the plant and method of the present disclosure allow generation of a surplus of useful power, improving the total power output of the concentrated solar plant with respect to a current art plant.

Here below reference will specifically be made to a system using water and steam, i.e. water vapor. However, the present disclosure more generally refers to a system where any suitable working fluid can be used. For example, the system and method of the present disclosure can be based on an organic Rankine cycle using an organic working fluid. Suitable working fluids can be pentane or cyclopentane or other hydrocarbons having suitable properties.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a concentrated solar power plant according to the current art;

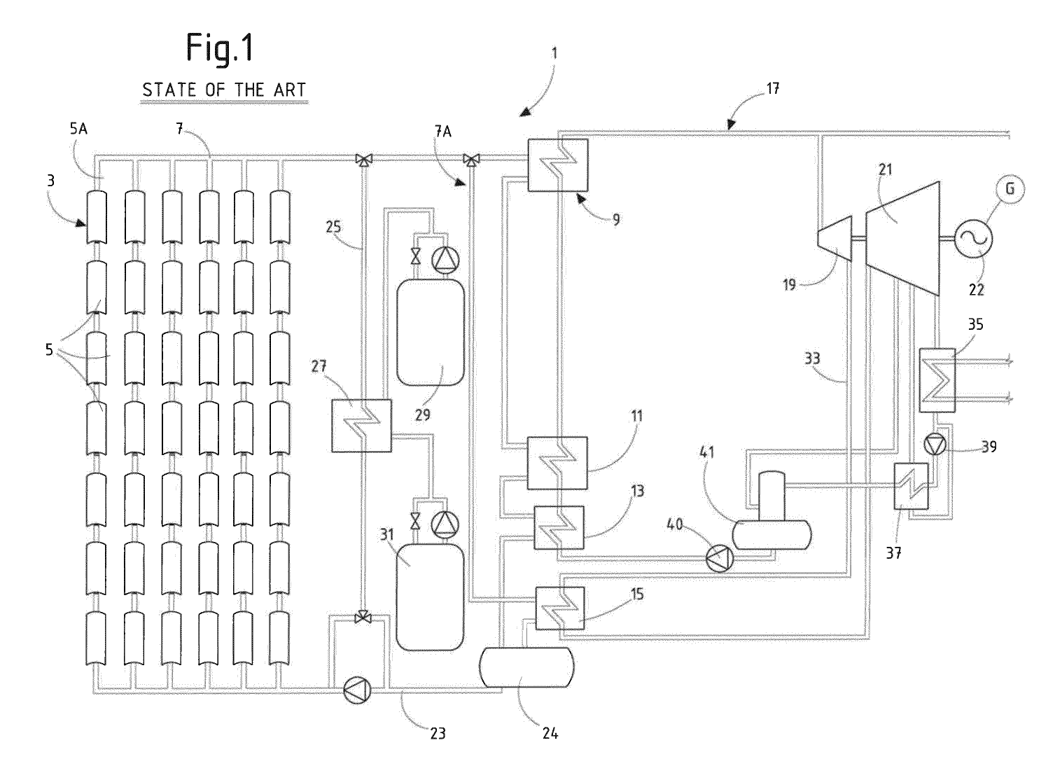

FIG. 2 illustrates a typical reheat steam turbine arrangement for a concentrated solar power plant with a high-pressure steam turbine working with superheated steam;

FIG. 3 illustrates a an embodiment of the present invention of a concentrated solar power plant according to the present disclosure;

FIGS. 3A and 3B illustrate two possible embodiments of solar concentrator arrangements for a concentrated solar power plant according to the present disclosure;

FIG. 4 illustrates the pressure-enthalpy diagram for a concentrated solar power plant using a modified Rankine cycle according to the present disclosure;

FIG. 5 illustrates a temperature-entropy diagram for the modified Rankine cycle according to the present disclosure in a simplified arrangement;

FIG. 6 illustrates a diagram similar to the diagram of FIG. 5, showing a reheated cycle;

FIG. 7 illustrates a concentrated solar power plant in a further embodiment;

FIGS. 8 to 11 illustrate different embodiments of a compressor arrangement for superheating the working fluid in the thermodynamic cycle of a concentrated solar power plant according to the present disclosure;

FIG. 12 illustrates a further embodiment of a concentrated solar power plant according to the present disclosure;

FIG. 13 illustrates the Mollier diagram for the concentrated solar power plant of FIG. 12.

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

In the following detailed description of some embodiments, the plant uses a thermodynamic cycle based on the Rankine cycle using water and steam as a working fluid. In other embodiments, as noted above, however, a different working fluid can be used. The operative method will be substantially the same, except that instead of steam, vapor of such different working fluid will be generated and processed.

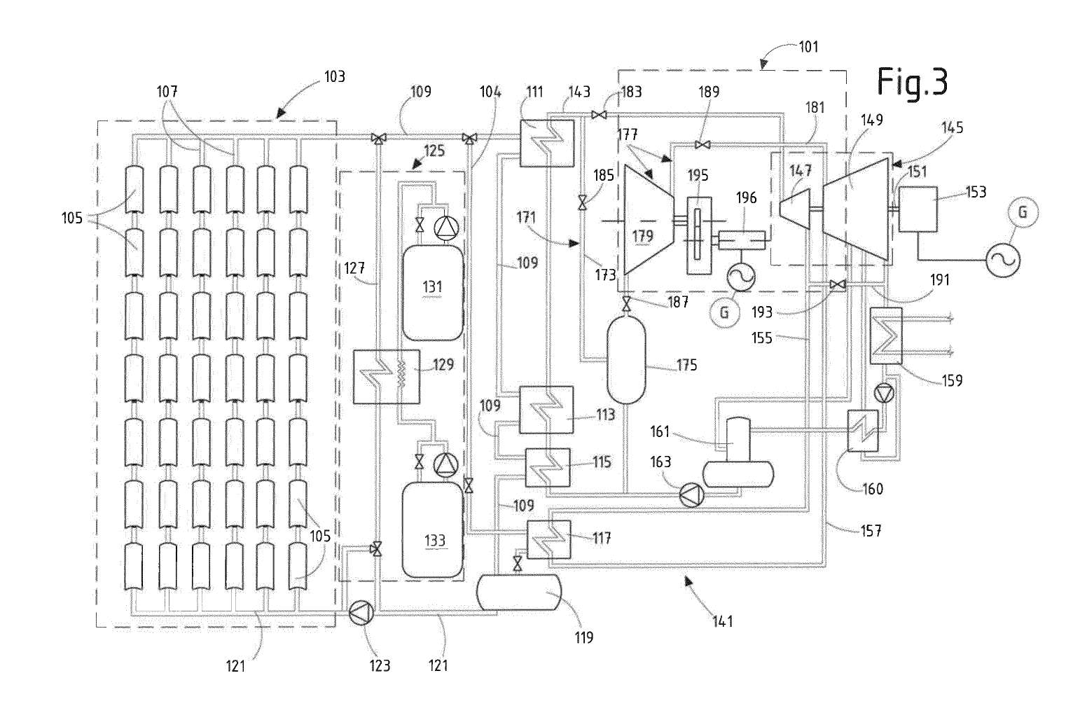

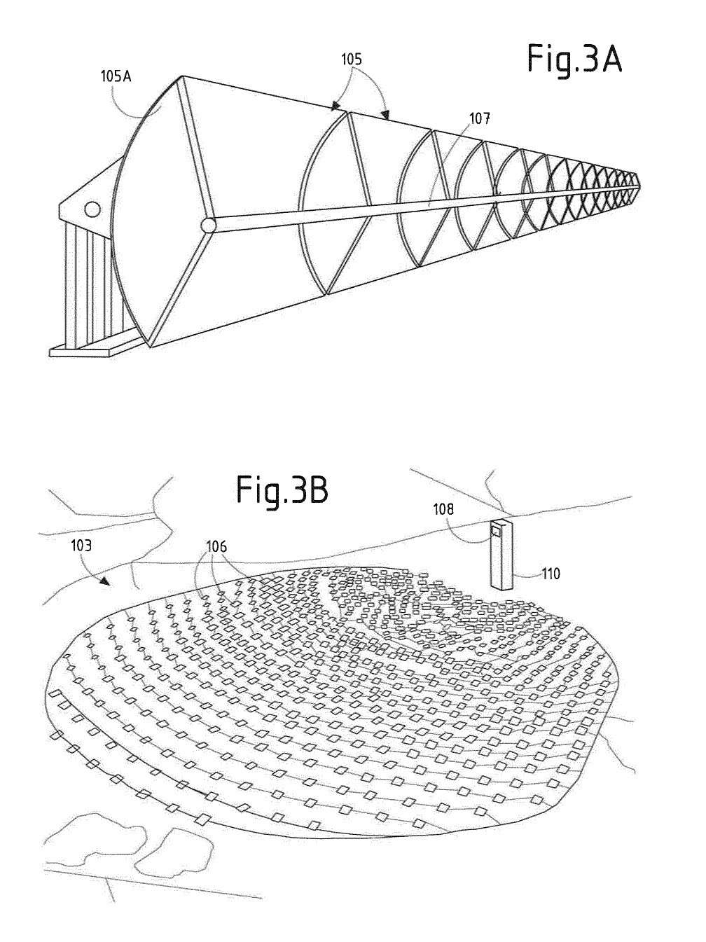

Referring to FIG. 3, the main components of a concentrated solar power plant 101 according to the disclosure will be described. The concentrated solar power plant 101 comprises a solar field 103. The solar field 103 comprises a plurality of solar concentrators 105. In the schematic diagram of FIG. 3 a solar field 103 comprising a plurality of troughs concentrators 105 is schematically represented. The concentrators focus the solar energy on a plurality of pipes 107, which are located in the focus of the parabolic troughs 105. FIG. 3A illustrates by way of example one such solar concentrator 105, which includes a parabolic mirror 105A, in the focus point whereof the pipe 107 is arranged. A heat transfer fluid flowing in the pipe 107 is thus heated by means of the solar energy, which is collected by the trough 105A.

In a manner known to those skilled in the art, the solar field 103 usually comprises a large number of solar concentrators 105 arranged in rows, each row being provided with one pipe 107 for collecting the thermal energy in the heat transfer medium flowing in the pipes 107. The troughs 105A are controlled to track the sun during the day so as to collect the maximum radiant energy.

In other embodiments the solar field 103 can be designed differently. FIG. 3B illustrates by way of example a solar field 103 comprising a plurality of planar mirrors 106, which are arranged so as to focus the solar energy in an area 108 on top of a tower 110. In the area 108 a heat exchanger is provided, through which the heat transfer medium circulates, in order to be heated by the solar energy focused by the mirrors 106. The mirrors 106 are motor-controlled to track the sun in order to maximize the solar energy concentrated on the area 108.

Turning now to the embodiment of FIG. 3, the pipes 107 are collected in a delivery duct 109, which delivers the heated heat transfer medium from the solar field 103 through a heat exchanger arrangement. In some embodiments the heat exchanger arrangement comprises a series of heat exchangers, which will here below referred to as a solar super-heater 111, a steam (i.e. water vapor) generator or evaporator 113 and a solar pre-heater 115. In other embodiments, not shown, two or more of the above mentioned heat exchangers can be combined to one another to form a single unit.

According to some embodiments, a solar re-heater 117 is further provided, through which a fraction of the heat transfer medium, flowing in a bypass line 104 is delivered. The heat transfer medium flowing in line 104 bypasses the solar super-heater 111, the steam generator 113 and the solar pre-heater 115. In other embodiments, no re-heat is provided.

In the serially arranged heat exchangers 111-115 the heat transfer medium transfers thermal energy at progressively lower temperatures to a working fluid circulating in a closed circuit, which will be described later on, wherein the working fluid performs a thermodynamic cycle, for example a Rankine cycle, to convert thermal energy or heat into mechanical energy and eventually into electric energy.

After passing through the heat exchangers, the cooled heat transfer medium is collected in an expansion vessel 119 and pumped by a pump 123 along a return duct 121 back into the solar field 103 again.

In some embodiments, an intermediate thermal energy storage arrangement 125 can be provided, for storing excess thermal energy available from the solar field 103. In some embodiments the thermal energy storage arrangement 125 can include a bypass line 127 receiving hot heat transfer medium from delivery duct 109 and delivering it through a heat exchanger 129, wherein thermal energy is transferred to a heat storage medium, which flows from a low-temperature tank 133 to a high-temperature tank 131. Thermal energy stored in the high-temperature tank 131 is returned back to the hot transfer medium by means of the heat exchanger 129, when required, e.g. when less solar energy is collected by the solar field 103.

The heat transfer medium, therefore, circulates in a close loop or circuit comprising the solar field 103, the hot side of the heat exchanger arrangement including the solar super-heater 111, the steam generator 113, the solar pre-heater 115, the solar re-heater 117, the delivery duct 109 and the return duct 121.

The thermal energy collected by the solar field 103 is transferred by the heat transfer medium through the heat exchangers 111-117 to a second closed circuit 141, wherein a working fluid circulates, which performs a thermodynamic cycle.

The closed circuit 141 includes the cold side of the solar super-heater 111, the steam generator 113, the solar pre-heater 115 and the solar re-heater 117.

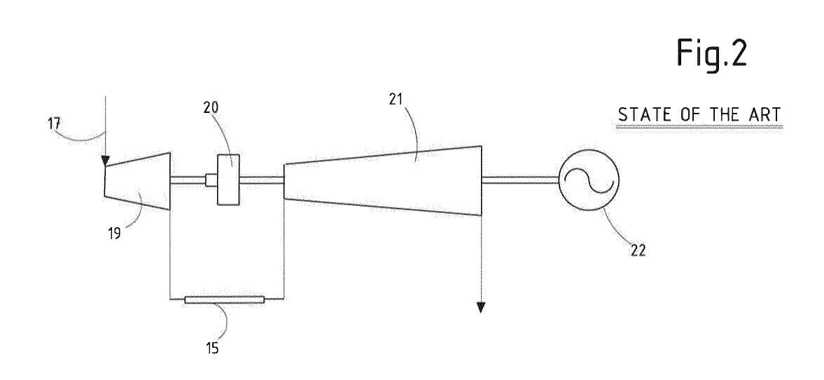

Superheated steam delivered by the solar super-heater 111 flows through a duct 143 towards a steam turbine arrangement 145. In some embodiments the steam turbine arrangement 145 comprises a first, high-pressure steam turbine 147 and a second, low-pressure steam turbine 149, arranged in sequence and including respectively a high-pressure rotor and a low-pressure rotor. The high-pressure rotor of the high-pressure steam turbine 147 and the low-pressure rotor of the low-pressure steam turbine 149 can be mounted on a common turbine shaft 151. The turbine shaft 151 can be linked to an electric generator 153, which converts mechanical power available on the turbine shaft 151 into electric power, which can be delivered to an electric distribution grid G. In some embodiments, the low-pressure turbine 149 and the high-pressure steam turbine 147 can rotate at different rotary speeds, as illustrated by way of example in FIG. 2. In this case a gearbox or another speed manipulation device is usually arranged between the high-pressure rotor shaft and the low-pressure rotor shaft. The shaftline formed by the two rotors and the gearbox arranged therebetween is then connected at one end to the electric generator 153.

In some embodiments the steam is partly expanded in the high-pressure steam turbine 147 and subsequently delivered to the solar re-heater 117 through a duct 155. In the solar re-heater 117 the partly expanded steam is reheated and the reheated steam is delivered through a duct 157 to the inlet of the low-pressure steam turbine 149.

Spent steam exiting the steam turbine arrangement 145 is condensed in a condenser 159 and finally delivered through a de-aerator 161 and to the solar pre-heater 115. In some embodiments a low-pressure pre-heater 160 can be arranged along the flow path of the condensed working fluid between the condenser 159 and the de-aerator 161. In the low-pressure pre-heater 160 the low-pressure condensed working fluid is pre-heated exchanging heat against a side-stream of steam bleeding from an intermediate stage of the low-pressure steam turbine 149.

A pump 163 boosts the pressure of the water or condensed working fluid collected in the de-aerator 161 to the required upper pressure and delivers the pressurized liquid working fluid through the solar pre-heater 115. From the solar pre-heater 115 the heated working fluid, still in the liquid state, is delivered through the steam generator 113 where it is vaporized and converted into saturated steam. The saturated steam is finally superheated in the solar super-heater 111.

The steam turbine system including the steam turbine arrangement 145, along with the piping and heat exchangers, de-aerator and condenser through which the working fluid flows in order to perform the thermodynamic cycle, further comprises a secondary circuit 171. The working fluid can be diverted in the secondary circuit 171, in order to be superheated by means of a supplemental-energy delivery device, when the thermal energy available from the solar field 103 is insufficient to achieve proper superheated conditions of the working fluid at the outlet of the solar super-heater 111.

In some embodiments the secondary circuit 171 comprises a diverting line 173, which is in fluid communication with the duct 143 leading from the solar super-heater 111 to the steam turbine arrangement 145. The diverting line 173 can be in fluid communication also with a water/steam separator 175. The steam outlet of the water/steam separator 175 can be connected to the inlet of a supplemental-energy delivery device 177.

In the embodiment illustrated in FIG. 3, the supplemental-energy delivery device 177 comprises a steam compressor 179. The steam compressor 179 can be a turbo-compressor, e.g. an axial or a centrifugal compressor. In some embodiments, the steam compressor 179 can comprise one or more compressor stages or separate compressor machines. Saturated steam or partly superheated steam from the water/steam separator 175 is delivered to the suction side of the steam compressor 179. The steam compressor 179 compresses the saturated steam to a pressure, which is sufficiently high to guarantee that at the outlet of the steam compressor 179 the steam is in a superheated condition suitable for expansion in the steam turbine arrangement 145. The delivery side of the steam compressor 179 can be put in fluid communication through a line 181 with the inlet of the low-pressure steam turbine 149. As will be described in greater detail here below, the secondary circuit 171 can be selectively connected to the main steam circuit, or isolated therefrom, depending upon the operative conditions of the solar field 103.

Along the duct 143 a first valve 183 is arranged, which is alternatively opened or closed depending upon the mode of operation of the thermodynamic cycle. A second valve 185 is provided along the diverting line 173, a third valve 187 is arranged between the outlet of the water/steam separator 175 and the suction side of the steam compressor 179.

A further fourth valve 189 is arranged along the line 181, between the delivery side of the steam compressor 179 and the inlet of the low-pressure steam turbine 149.

A bypass 191 can be provided between the duct 155 and the discharge side of the low-pressure steam turbine 149. A valve 193 can be provided on the bypass line 191. As will be described in greater detail later on, under certain operating conditions the high-pressure turbine 147 is bypassed and only the low-pressure steam turbine 149 is operative. In this case the interior of the high-pressure steam turbine 147 must be placed under vacuum conditions. This is obtained by opening valve 193 and connecting the inoperative high-pressure turbine 147 with the condenser 159 through bypass line 191.

The supplemental-energy delivery device 177 further comprises a mover for driving the steam compressor 179. In the embodiment illustrated in FIG. 3 the mover comprises an electric motor 196. The electric motor 196 can be powered by the electric distribution grid G, or directly by the electric generator 153. A gearbox 195 can be arranged between the electric motor 196 and the steam compressor 179, if the rotary speed of the electric motor 196 is different from the speed of the steam compressor 179. Other speed manipulation devices can be used instead of a gearbox.

The concentrated solar power plant 101 described so far with reference to FIG. 3 operates as follows.

Under normal operating conditions, when sufficient solar energy is collected by the solar field 103, the concentrated solar power plant of FIG. 3 operates substantially in the same way as a plant of the current art. The thermal energy is extracted from the solar field 103 by the heat transfer medium flowing in the ducts 109, 104, 121 so that the solar thermal energy is transferred to the working fluid circulating in the steam turbine system of the second closed circuit 141.

The working fluid circulating in the steam turbine system performs a Rankine cycle converting thermal power collected by the solar field 103 into mechanical power available on the turbine shaft 151.

The secondary circuit 171 is closed. The valves 185, 187 and 189 are closed, while the valve 183 is opened. The superheated steam flows along duct 143 into the high-pressure steam turbine 147. The partly expanded steam is re-heated in the re-heater 117 and finally expanded in the low-pressure steam turbine 149. The spent steam is condensed in condenser 159 and delivered to the solar pre-heater 115, where the water is heated and subsequently transformed into steam in the steam generator 113 and again superheated in the solar super-heater 111.

If the thermal power available from the solar field 103 is insufficient to generate a suitable flow of superheated working fluid at the outlet of the solar super-heater 111, the steam turbine system is switched to a modified operating mode, wherein the working fluid is superheated using the supplemental-energy delivery device 177. The valve 183 is closed, while the valves 185, 187 and 189 are opened.

Working fluid in a saturated steam condition or in an insufficiently super-heated condition is delivered through the diverting line 173 in the water/steam separator 175. Water is drained from the bottom of the water/steam separator 175 and flows back to the solar pre-heater 115, while saturated steam is delivered through valve 187 into the steam compressor 179. The steam compressor 179 introduces energy in the steam by increasing the pressure thereof in a substantially adiabatic compression step. The steam delivered by the steam compressor 179 is therefore in a superheated condition and at a pressure, which is higher than the outlet pressure at the solar super-heater 111. Usually, the compressor delivery pressure is lower than the pressure of the superheated steam delivered by the solar super-heater 111 when the concentrated solar power plant 111 is operating in design conditions, i.e. when the steam is superheated using the solar energy.

The super-heated and partially pressurized steam is delivered through valve 189 to the low-pressure steam turbine 149, by-passing the high-pressure steam turbine 147. By flowing through the low-pressure steam turbine 149 the steam is expanded and the energy contained therein is at least partly converted into mechanical power available on the turbine shaft 151. Spent steam exiting the low-pressure steam turbine 149 is condensed in the condenser 159 and undergoes the usual further transformations until it is again delivered, in the liquid phase, through the solar pre-heater 115, the steam generator 113 and the solar super-heater 111.

Under these modified operating conditions the re-heater circuit as well as the high-pressure steam turbine 147 are inoperative, the valve 183 being closed.

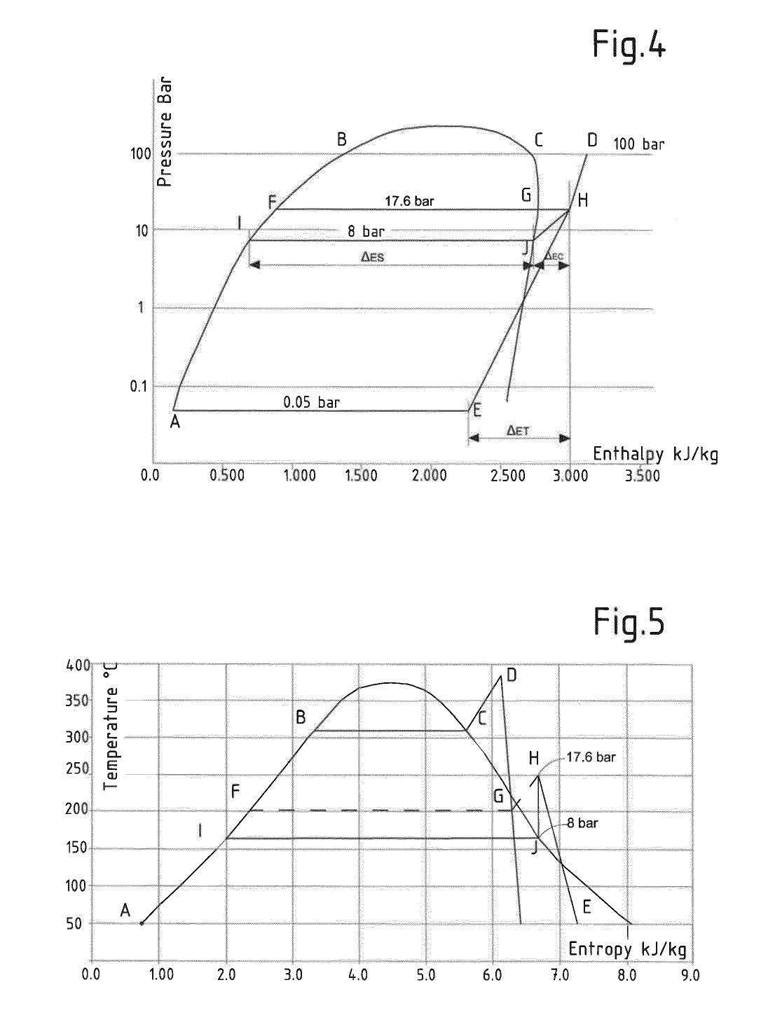

FIG. 4 illustrates a pressure/enthalpy diagram, showing three different operating conditions of the concentrated solar power plant of FIG. 3.

Under normal design conditions the thermodynamic cycle performed by the working fluid in the circuit 141 is represented by points A, B, C, D and E. In an exemplary embodiment the low pressure in the cycle can be around 0.05 bar, said pressure being achieved by the condenser system 159 and the condensate is pumped into the de-aerator by the condensate pump through low pressure heater(s) 160. The feed pump 163 boosts the fluid pressure from the pressure in the de-aerator 161 to the high cycle pressure of e.g. around 100 bar and the fluid is heated up to point B before starting the water/steam phase change ending at C, said point being on the saturation line. The saturated steam is then superheated reaching point D, which represents the working fluid condition at the output of the solar super-heater 111. Superheated steam is expanded in the steam turbine arrangement 145 from point D to point E. In the schematic diagram of FIG. 4 steam re-heating is omitted.

Under minimum load conditions the Ranking cycle is defined by curve AFGH. An upper working fluid pressure of e.g. around 17.6 bar with superheat, suitable for operation of the high pressure steam turbine is achieved from saturated steam pressure of about 8 bar. Said upper pressure value is substantially lower than the pressure in design conditions. Sufficient solar energy is available for superheating the steam from point G to point H and the superheated steam is then expanded in the steam turbine arrangement 145. Also in this case re-heating is not represented in the diagram.

If even less solar energy is available, the concentrated solar power plant will not be able to perform a standard Rankine cycle. The plant is therefore switched to the modified operation mode, where supplemental energy is delivered to the working fluid by the supplemental-energy delivery device 177. The thermodynamic cycle performed by the working fluid is in this case represented by the curve AIJHE. The cycle is operated at an upper pressure, which is lower than the minimum operating pressure of the normal cycle, e.g. an upper pressure of around 8 bar. Between point I and point J of the curve the water is heated and transformed into saturated steam at point J using the solar energy available from the solar field 103. Point J represents the condition of the saturated steam at the outlet of the solar super-heater 111. Under these conditions the super-heater 111 actually operates as a steam generator exchanger, since the steam delivered by the super-heater is in saturated or approximately saturated conditions. AES is the energy provided by the solar field 103. The saturated steam is then delivered through the steam compressor 179, and is brought in the condition represented by point H at a higher pressure of for example around 17.6 bar, in a superheated condition. ΔEC represents the energy supplied by the steam compressor 179. The subsequent steam expansion from point H to point E provides mechanical energy. ΔET is the useful mechanical energy produced by the low-pressure steam turbine 149.

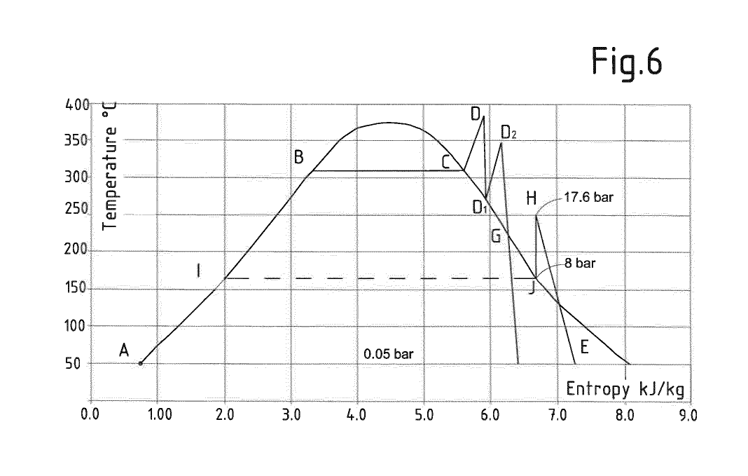

FIG. 5 illustrates the same thermodynamic cycle on a temperature-entropy diagram. Also in this case the reheating step is not shown.

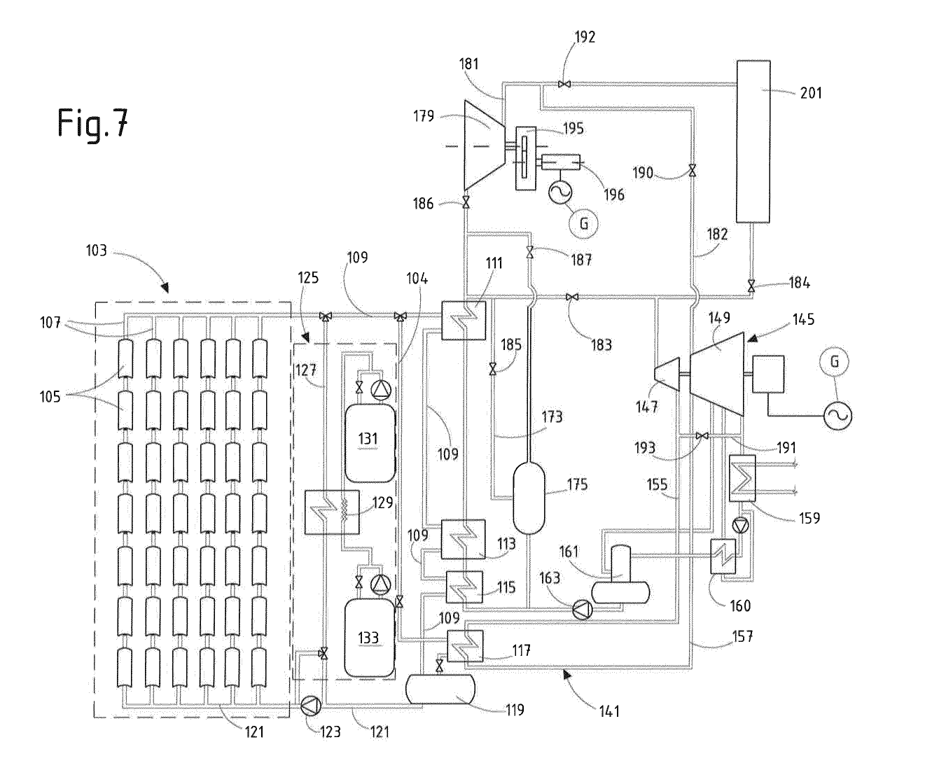

In both diagrams of FIGS. 4 and 5 the thermodynamic cycle has been represented in a simplified embodiment, where no re-heating is provided. The same considerations apply in case of a re-heated cycle. FIG. 6 illustrates the same curves as FIG. 5 in a situation where the normal operating conditions provide for re-heating of the steam after expansion in the high-pressure steam turbine 147. In this case in normal operating conditions, i.e. when the solar field 103 delivers sufficient solar power to superheat the steam in the Rankine cycle, steam is superheated up to point D, expanded in the high-pressure steam turbine 147 to point D1 and then re-heated in the re-heater 117 to reach point D2. From there the re-heated steam is expanded in the low-pressure steam turbine 149 to the low cycle pressure and condensed (point A). Curve A, I, J, H, E illustrates the thermodynamic cycle in the modified operating condition, where superheating (curve JH) is performed by the steam compressor 179.

The pressure and temperature values reported in FIGS. 4, 5 and 6 are to be considered as exemplary and not limiting.

In the exemplary embodiment of FIG. 3, the steam compressor 179 is used only to superheat the saturated steam when the solar energy is insufficient to run the turbine arrangement with a standard Rankine cycle. In other embodiments the steam compressor 179 can be used also for additional functions.

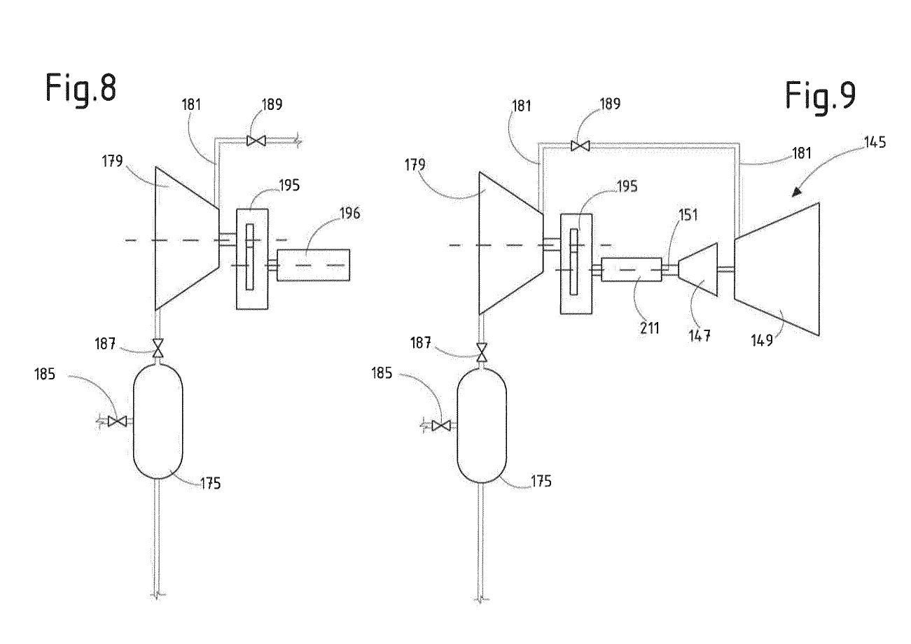

FIG. 7, for example, illustrates an embodiment wherein the steam compressor 179 is used during operation of the Rankine cycle in the normal mode, i.e. when steam superheating is obtained by solar energy in the solar super-heater 111. Under these operating conditions the steam compressor 179 is used for storing steam at a pressure higher than the design point pressure, for example at twice the upper operating pressure of the Rankine cycle. The high-pressure stored steam can be used for extending the period of operation of the Rankine cycle. In FIG. 7 the same elements as in FIG. 3 are labeled with the same reference numbers.

The suction side of the steam compressor 179 can be fluidly connected via valve 187 to the water/steam separator 175 or via a valve 186 directly with the solar super-heater 111. The delivery side of the steam compressor 179 can be placed in fluid communication through line 181 with the inlet of the low-pressure steam turbine 149 or, alternatively, with a steam storage tank 201. An additional valve 190 is provided on a line 182 branched off from line 181.

When the steam compressor 179 is used to superheat the steam delivered from the solar super-heater 111, the valves 189 and 190 are both open. A valve 192 arranged between the connection of line 182 and the steam storage tank 201 is closed. Valve 186 between the solar super-heater 111 and the steam compressor 179 is also closed. Operation under these conditions is the same as described above with reference to the embodiment of FIG. 3.

When sufficient solar energy is available from the solar field 103, part of the superheated steam can be delivered through valve 186 to the steam compressor 179. The steam pressure is boosted e.g. to twice the pressure in the heat exchanger arrangement 111, 113, 117. The pressurized steam is stored in the steam storage tank 201. The valve 190 is closed and valve 192 is open. A valve 184 connecting the steam storage tank 201 to the inlet of the high-pressure steam turbine 147 is closed. When the solar energy collected by the solar field 103 is insufficient to generate the required flow of superheated steam, the compressed superheated steam stored in the steam storage tank 201 can be temporarily used to drive the high-pressure steam turbine 147 and the low-pressure steam turbine 149 by opening the valve 184 and closing the valve 183, thus extending the period during which the high-pressure steam turbine 147 can be operated.

In the embodiment illustrated in FIGS. 3 and 7 the steam compressor 179 is driven by the electric motor 196 through a gearbox 195. Other embodiments provide for different ways of driving the steam compressor 179.

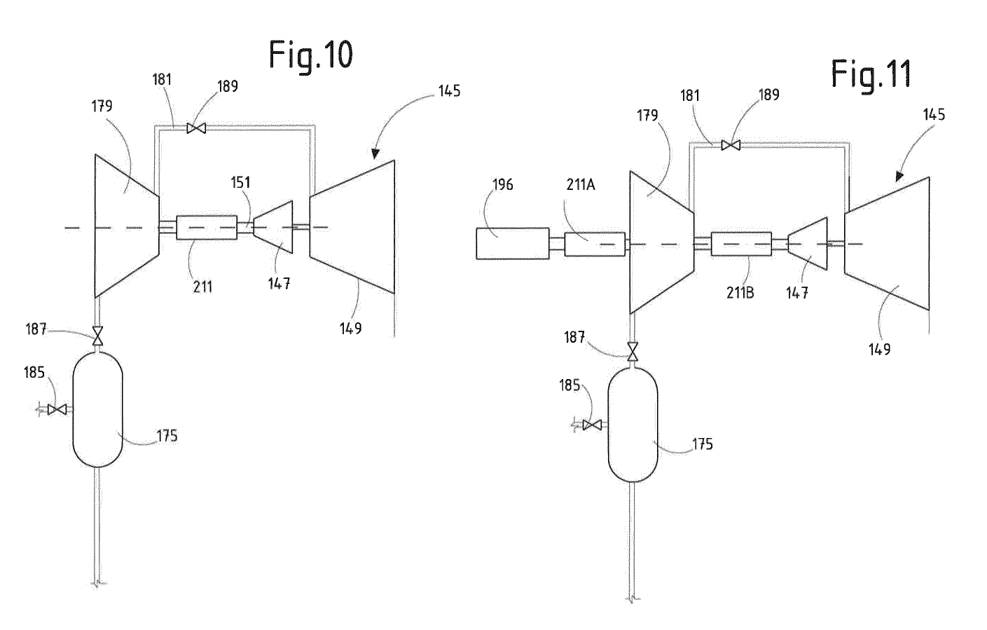

FIGS. 8 through 11 schematically represent four alternative embodiments of different steam compressor driving systems. In FIG. 8 the steam compressor 179 is driven by the electric motor 196 through the gearbox 195. This is the exemplary arrangement used in the plants illustrated in FIGS. 3 and 7. In FIG. 9 the steam compressor 179 is driven by the steam turbine arrangement 145. A clutch 211 selectively connects the shaft 151 of the steam turbine arrangement 145 to a gearbox 195, and disconnects the shaft 151 from said gearbox 195. Rotary motion is transmitted from the steam turbine shaft 151 through the clutch 211 and the gearbox 195. The mechanical power available on the output turbine shaft 151 is directly used to drive the steam compressor 179.

According to a further embodiment, illustrated in FIG. 10, the steam compressor 179 is driven by mechanical power directly delivered through the steam turbine shaft 151. In this embodiment a clutch 211 is arranged between the steam turbine arrangement 145 and the steam compressor 179. In this embodiment, differently from the embodiment of FIG. 9, however, the steam compressor 179 is driven at the same speed as the turbine shaft 151, so that a gearbox can be dispensed with.

FIG. 11 shows yet a further embodiment, wherein the steam compressor 179 is driven alternatively or in combination by means of mechanical power generated by the steam turbine arrangement 145 and/or by means of an electric motor 196. A first clutch 211A is arranged for selectively connecting the electric motor 196 to the steam compressor 179, or disconnecting the electric motor 196 from the steam compressor 179. A second clutch 211B is arranged between the steam turbine arrangement 145 and the steam compressor 179. The second clutch 211B can selectively connect the steam turbine arrangement 145 to the steam compressor 179 or disconnect the two machines one from the other. The arrangement of FIG. 11 can be used to drive the steam compressor 179 by means of the electric motor 196 only, by means of the steam turbine arrangement 145 only, or by the combination of both the electric motor 196 and the steam turbine arrangement 145. The selection of either one or the other of the movers 196, 145 can depend upon the available power, or upon the rotary speed which is required under certain given operating conditions. Other parameters can be taken into consideration when selecting one or the other of the two movers 196, 145. In other embodiments, not shown, a gearbox can be arranged between the clutch 211A and the steam compressor 179 and/or between the clutch 211B and the steam compressor 179.

In FIGS. 8 to 11 the high-pressure steam turbine 147 and the low-pressure steam turbine 149 are provided with a single shaft 151. The rotors of the two steam turbines 147, 149 rotate in such case at the same rotary speed. In other exemplary embodiments, the two steam turbines can rotate at different speeds and a gearbox (not shown), or a different speed manipulation device, can be arranged between a low-pressure turbine shaft and a high-pressure turbine shaft.

In further embodiments, a different supplemental-energy delivery device can be used instead of a steam compressor 179.

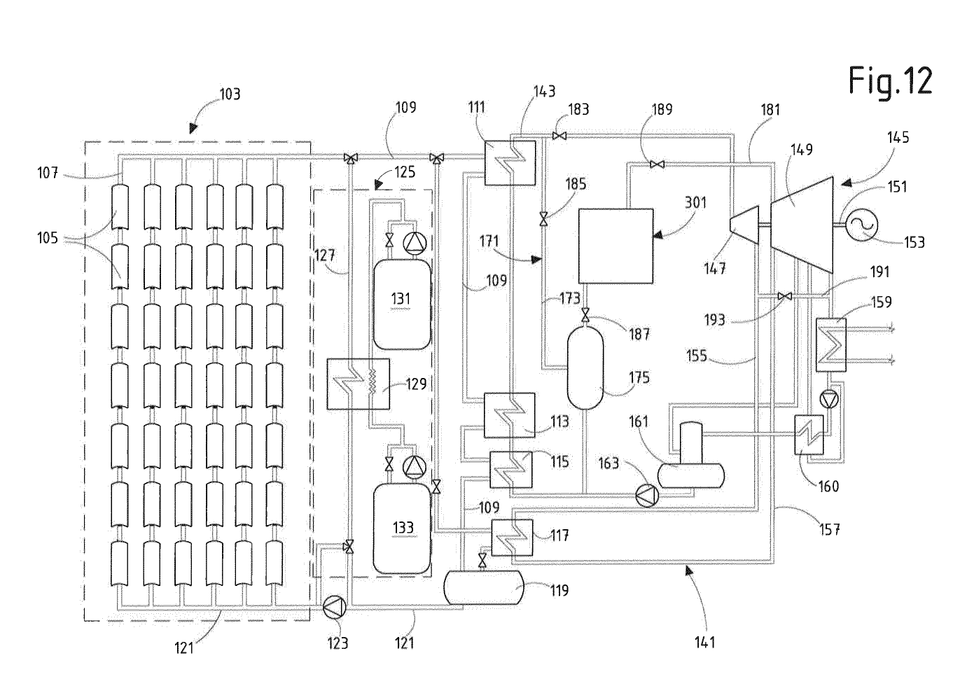

FIG. 12 illustrates a concentrated solar power plant using a steam turbine arrangement and a supplemental-energy delivery device to operate the plant when insufficient solar energy is available for the production of superheated steam. The same reference numbers as used in FIG. 3 are used to indicate the same or equivalent elements, components or parts of the system.

In the embodiment of FIG. 12, an auxiliary heating device 301 is used instead of the steam compressor 179. The auxiliary heating device 301 can include, for example, a gas burner and/or a liquid fuel burner to generate thermal energy, which is delivered to the saturated or partially superheated steam coming from the water steam/separator 175. In this embodiment, therefore, the supplemental energy is delivered to the working fluid circulating in the circuit 141 in the form of thermal energy rather than in the form of mechanical energy. Steam is superheated without increasing the pressure thereof.

The superheated steam from the supplemental-energy delivery device 301 is again delivered to the low-pressure steam turbine 149 and expanded therein to produce mechanical power, before being collected and condensed in the condenser 159.

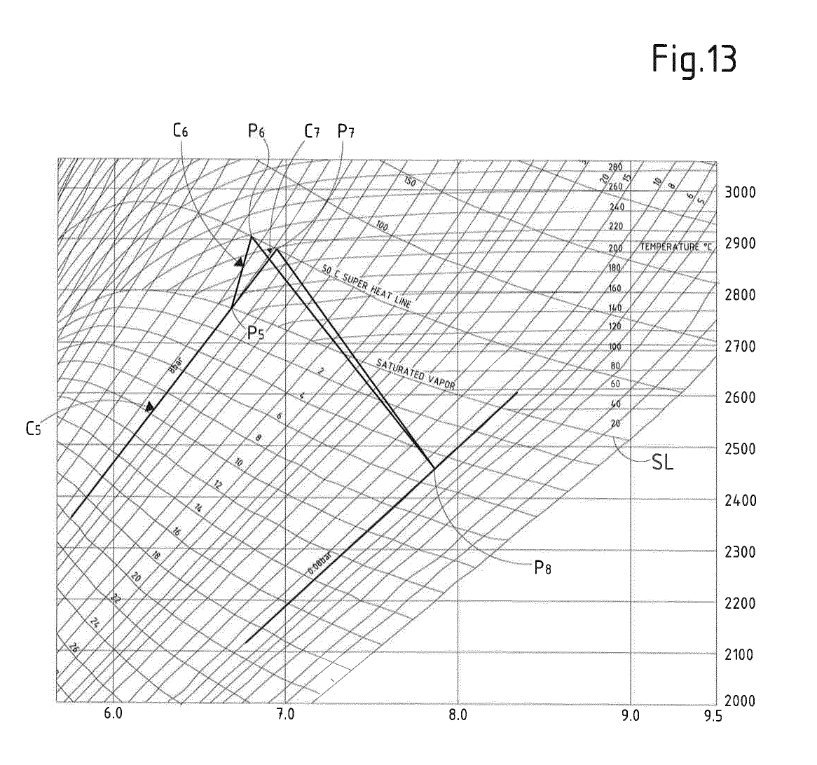

FIG. 13 shows a Mollier diagram similar to the diagram of FIG. 6, wherein the two alternative ways of supplementing energy to the working fluid are compared.

The curve C5 ending on the saturation line SL at point P5 represents the vaporization step. From point P5 the saturated steam can be superheated by compression using steam compressor 179 (FIG. 3) along line C6 reaching point P6. Alternatively, if arrangement of FIG. 12 is used, the steam is superheated by means of thermal power from the supplemental-energy delivery device 301. The superheating curve is in this case represented by line C7 ending at point P7. From either point P6 or P7 the superheated steam is expanded to 0.08 bar (point P8).

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A concentrated solar power plant comprising:
a solar field;
a vapor turbine system comprising a vapor turbine arrangement receiving superheated vapor generated by heating a working fluid circulating in the vapor turbine system;
a thermal transfer system configured to transfer solar thermal energy from the solar field to the vapor turbine system; and
a supplemental-energy delivery device configured to superheat the vapor when the solar thermal energy from the solar field is insufficient to generate sufficient superheated vapor,
wherein the supplemental-energy delivery device comprises a vapor compressor.

2. The plant of claim 1, wherein the vapor turbine system further comprises a Rankine cycle system.

3. The plant of claim 1, further comprising:
a heat transfer medium circuit receiving thermal energy from the solar field;
a working fluid circuit;
a heat exchanger arrangement configured to transfer thermal energy from heat transfer medium, circulating in the heat transfer medium circuit, to the working fluid.

4. The plant of claim 3, wherein the heat exchanger arrangement comprises a vapor generator and a super-heater.

5. The plant of claim 3, wherein the working fluid circuit comprises a secondary circuit configured to selectively divert the working fluid from the heat exchanger arrangement through the supplemental-energy delivery device and therefrom to the vapor turbine arrangement.

6. The plant of claim 1, wherein the vapor turbine arrangement comprises a high-pressure vapor turbine and a low-pressure vapor turbine, and wherein the supplemental-energy delivery device is configured to deliver superheated vapor to the low-pressure vapor turbine, bypassing the high-pressure vapor turbine.

7. The plant of claim 1, wherein the heat exchanger arrangement comprises a reheater, wherein the reheater is configured to receive thermal energy from the heat transfer medium circuit, receive partly expanded vapor from the high-pressure vapor turbine, reheat the partly expanded vapor, and deliver the reheated vapor to the low-pressure vapor turbine, and wherein the reheater is inoperative when the supplemental-energy delivery device is in operation.

8. The plant of claim 6, wherein, depending upon the solar thermal energy available from the solar field, the heat exchanger arrangement comprises a super-heater in fluid communication selectively:
with the high-pressure vapor turbine,
or with a secondary circuit of the working fluid circuit and the supplemental-energy delivery device.

9. The plant of claim 6, wherein the vapor turbine system is configured to selectively:
expand the superheated vapor sequentially in the high-pressure vapor turbine and in the low-pressure vapor turbine to produce mechanical power, when the vapor is superheated by solar thermal energy; or
the high-pressure vapor turbine and expand the superheated vapor in the low-pressure vapor turbine to produce mechanical power, when the vapor is superheated by energy delivered by the supplemental-energy delivery device.

10. The plant of claim 1, wherein the vapor compressor is driven by a motor.

11. The plant of claim 1, wherein the vapor compressor is driven by the vapor turbine system.

12. The plant of claim 1, further comprising a high-pressure vapor accumulator, and wherein the vapor compressor is configured for selective fluid connection with the high-pressure vapor accumulator or with the vapor turbine arrangement.

13. The plant of claim 6, wherein the supplemental-energy delivery device comprises an auxiliary heating device delivering thermal energy to the working fluid for superheating the vapor.

14. A method for operating a concentrated solar power plant, the method comprising:
collecting solar thermal energy with a solar field;
generating superheated vapor by heating a working fluid with the solar thermal energy;
expanding the superheated vapor in a vapor turbine arrangement and generating mechanical power therewith; and
supplementing the solar thermal energy with supplemental energy delivered by a supplemental-energy delivery device comprising a vapor compressor, superheating the vapor by compressing the vapor from a first pressure level to a second pressure level for superheating vapor delivered to the vapor turbine arrangement, when the solar thermal energy is insufficient to generate sufficient superheated vapor.

15. The method of claim 14, further comprising:
circulating a heat transfer medium in a first circuit for transferring solar thermal energy from the solar field to a second circuit;
circulating a working fluid in the second circuit, the working fluid performing a thermodynamic cycle to convert at least part of the solar thermal energy into mechanical energy in the vapor turbine arrangement;
processing the working fluid in the supplemental-energy delivery device for supplementing energy to the working fluid, when the solar thermal energy is insufficient to generate sufficient superheated vapor.

16. The method of claim 15, wherein the thermodynamic cycle is a Rankine cycle.

17. The method of claim 15, wherein the working fluid is expanded sequentially in a high-pressure vapor turbine and in a low-pressure vapor turbine when the solar thermal energy is sufficient to generate superheated vapor, and wherein the high-pressure vapor turbine is by-passed and the superheated vapor is expanded in the low-pressure vapor turbine when solar thermal energy is supplemented with the supplemental-energy delivered by the supplemental-energy delivery device.

18. The method of claim 15, wherein the vapor compressor is driven by the vapor turbine arrangement.

19. The method of claim 15, wherein the vapor compressor is driven by a motor.

20. A method for operating a concentrated solar power plant, the method comprising:
collecting solar thermal energy with a solar field;
pressurizing a working fluid in a liquid state at a first pressure level;
directly or indirectly transferring solar thermal energy to the pressurized working fluid and at least partly evaporating the pressurized working fluid, generating a vapor flow;
superheating the vapor flow by compressing the vapor flow to a second pressure level thus delivering a supplemental energy to the vapor flow; and
expanding the superheated vapor flow in a vapor turbine to generate mechanical power.

21. The method of claim 20, further comprising indirectly transferring the solar thermal energy from the solar field to the pressurized working fluid through a closed heat transfer medium circuit.

22. The method of claim 20, further comprising:
providing a high-pressure vapor turbine and a low-pressure vapor turbine; and
expanding the superheated vapor flow in the low-pressure vapor turbine, by-passing the high-pressure vapor turbine.

23. A method for operating a concentrated solar power plant, the method comprising:
providing a vapor turbine arrangement;
collecting solar thermal energy with a solar field; and
transferring solar thermal energy to a pressurized working fluid and at least partly evaporating the pressurized working fluid generating a vapor flow,
wherein:
if the solar thermal energy is insufficient to superheat the vapor flow for expansion in the vapor turbine arrangement:
pressurizing the working fluid at a first pressure;
delivering a supplemental energy to the pressurized vapor flow for superheating the vapor flow;
delivering the superheated vapor flow to a low-pressure section of the vapor turbine arrangement; and
expanding the superheated vapor flow in the low-pressure section to a condensing pressure, generating mechanical power, and
if the solar thermal energy is sufficient to superheat the vapor flow for expansion in the vapor turbine arrangement:
pressurizing the working fluid at a second pressure, higher than the first pressure; and
expanding the superheated vapor flow, sequentially in a high-pressure vapor turbine section and in the low-pressure vapor turbine section of the vapor turbine arrangement from the second pressure to the condensing pressure, generating mechanical power.

24. The method of claim 23, wherein delivering a supplemental energy to the vapor flow comprises:
compressing the vapor flow at a third pressure, intermediate the first pressure and the second pressure; and
expanding the superheated vapor flow in the low-pressure vapor turbine section from the third pressure to the condensing-pressure, generating mechanical power.

25. The method of claim 23, wherein delivering a supplemental energy to the vapor flow comprises heating the vapor flow with thermal energy from a heat source different from the solar field.
